(19) United States
(12) Patent Application Publication
(10) Pub. No.: US 2013/0016630 A1
(43) Pub. Date: Jan. 17, 2013

(54) BEACONS FOR USER EQUIPMENT RELAYS

(71) Applicants: NAGA BHUSHAN, SAN DIEGO, CA (US); ALEKSANDAR DAMNJANOVIC, SAN DIEGO, CA (US); GAVIN B. HORN, SAN DIEGO, CA (US); YONGBIN WEI, SAN DIEGO, CA (US); DURGA PRASAD MALLADI, SAN DIEGO, CA (US)

(72) Inventors: NAGA BHUSHAN, SAN DIEGO, CA (US); ALEKSANDAR DAMNJANOVIC, SAN DIEGO, CA (US); GAVIN B. HORN, SAN DIEGO, CA (US); YONGBIN WEI, SAN DIEGO, CA (US); DURGA PRASAD MALLADI, SAN DIEGO, CA (US)

(73) Assignee: QUALCOMM INCORPORATED, San Diego, CA (US)

(21) Appl. No.: 13/546,963

(22) Filed: Jul. 11, 2012

Related U.S. Application Data
(60) Provisional application No. 61/506,967, filed on Jul. 12, 2011.

(51) Int. Cl. H04W 88/04; H04B 7/14

(52) U.S. Cl. 370/255; 370/315

(57) ABSTRACT

Certain aspects of the present disclosure provide methods and apparatus for detecting user equipment (UE) relays using beacons (whether in-band or out-of-band) or other mechanisms. One method generally includes determining an identifier indicative of a UE functioning as a relay and transmitting a broadcast signal including the identifier. Another method generally includes receiving, at a UE functioning as a relay, first broadcast signals at a first interval from an apparatus serving the UE; and transmitting second broadcast signals at a second interval, wherein the second broadcast signals are the same type as the first broadcast signals and wherein the second interval is greater than the first interval.

### CROSS-REFERENCE TO RELATED APPLICATIONS

This application claims benefit of priority to U.S. Provisional Application Ser. No. 61/506,967, filed on Jul. 12, 2011, which is expressly incorporated by reference herein in its entirety.

### BACKGROUND

1. Field

Certain aspects of the disclosure generally relate to wireless communications and, more particularly, to beacons or other mechanisms for discovering User Equipment (UE) devices functioning as relays.

2. Background

Wireless communication networks are widely deployed to provide various communication services such as voice, video, packet data, messaging, broadcast, etc. These wireless networks may be multiple-access networks capable of supporting multiple users by sharing the available network resources (e.g., bandwidth and transmit power). Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, 3^{rd} Generation Partnership Project (3GPP) Long Term Evolution (LTE) networks, and Long Term Evolution Advanced (LTE-A) networks.

A wireless communication network may include a number of base stations that can support communication with a number of user equipment devices (UEs). A UE may communicate with a base station via the downlink and uplink. The downlink (or forward link) refers to the communication link from the base station to the UE, and the uplink (or reverse link) refers to the communication link from the UE to the base station. A base station may transmit data and control information on the downlink to a UE and/or may receive data and control information on the uplink from the UE. This communication link may be established via a single-input single-output, multiple-input single-output or a multiple-input multiple-output (MIMO) system.

Wireless communication systems may comprise a donor base station that communicates with wireless terminals via a relay node, such as a relay base station. The relay node may communicate with the donor base station via a backhaul link and with the terminals via an access link. In other words, the relay node may receive downlink messages from the donor base station over the backhaul link and relay these messages to the terminals over the access link. Similarly, the relay node may receive uplink messages from the terminals over the access link and relay these messages to the donor base station over the backhaul link. The relay node may, thus, be used to supplement a coverage area and help fill “coverage holes.”

### SUMMARY

In an aspect of the disclosure, a method for wireless communications is provided. The method generally includes determining an identifier indicative of a user equipment (UE) functioning as a relay and transmitting a broadcast signal including the identifier.

In an aspect of the disclosure, a method for wireless communications is provided. The method generally includes receiving a broadcast signal including an identifier and determining, based on the identifier, that the broadcast signal was received from a UE functioning as a relay.

In an aspect of the disclosure, a method for wireless communications is provided. The method generally includes receiving, at a UE functioning as a relay, first broadcast signals at a first interval from an apparatus serving the UE; and transmitting second broadcast signals at a second interval, wherein the second broadcast signals are the same type as the first broadcast signals and wherein the second interval is greater than the first interval.

In an aspect of the disclosure, a method for wireless communications is provided. The method generally includes receiving, from a UE functioning as a relay, first broadcast signals at a first interval; and detecting the UE based on the first broadcast signals, wherein the first broadcast signals are the same type as second broadcast signals transmitted at a second interval by an apparatus serving the UE and wherein the first interval is greater than the second interval.

In an aspect of the disclosure, a method for wireless communications is provided. The method generally includes determining, at a first UE functioning as a relay, a first frequency used for relaying data to or receiving data from a second UE; and transmitting a beacon at a second frequency different from the first frequency.

In an aspect of the disclosure, a method for wireless communications is provided. The method generally includes receiving, from a UE functioning as a relay, a beacon at a first frequency; and discovering the UE based on the beacon, wherein the first frequency is different from a second frequency at which data is received from the UE.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates an example wireless communication system according to an aspect of the present disclosure.

FIG. 2 is a block diagram conceptually illustrating an example of a Node B in communication with a user equipment device (UE) in a wireless communication system, according to an aspect of the present disclosure.

FIG. 3 illustrates an example wireless communications system with a relay UE according to an aspect of the present disclosure.

FIG. 4 is a flow diagram of example operations for broadcasting an identifier indicative of a UE functioning as a relay, according to an aspect of the present disclosure.

FIG. 5 is a flow diagram of example operations for detecting a UE functioning as a relay based on an identifier in a broadcast signal, according to an aspect of the present disclosure.

FIG. 6 is a flow diagram of example operations for transmitting broadcast signals with a greater interval than received broadcast signals of the same type, from the perspective of a UE relay, for example, according to an aspect of the present disclosure.

FIG. 7 is a flow diagram of example operations for detecting a UE functioning as a relay based on broadcast signals with a greater interval than broadcast signals of the same type transmitted by an apparatus serving the UE functioning as a relay, from the perspective of a terminal UE, for example, according to an aspect of the present disclosure.

FIG. 8 is a flow diagram of example operations for transmitting an out-of-band beacon from the perspective of a UE relay, for example, according to an aspect of the present disclosure.

FIG. 9 is a flow diagram of example operations for discovering a UE functioning as a relay based on an out-of-band beacon from the perspective of a terminal UE, for example, according to an aspect of the present disclosure.

### DESCRIPTION

Certain aspects of the present disclosure generally relate to techniques that allow for the detection of user equipments (UEs) capable of serving as relays. For example, the techniques may provide techniques for transmitting beacons that identify such UEs in a relatively simple and power efficient manner.

While certain aspects presented herein may be used with out-of-band-relays that communicate with other UEs on “access-hop” channels (e.g., unlicensed white-space spectrum) outside of frequency bands used to communicate with a serving base station on a “backhaul-hop” (e.g., licensed spectrum), these aspects may be readily applied to in-band/out-of-band relays using licensed spectrum (e.g., LTE spectrum) for both backhaul and access, as well as to UE Relays with non-LTE backhaul (e.g., including wired backhaul).

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

### AN EXAMPLE WIRELESS COMMUNICATION SYSTEM

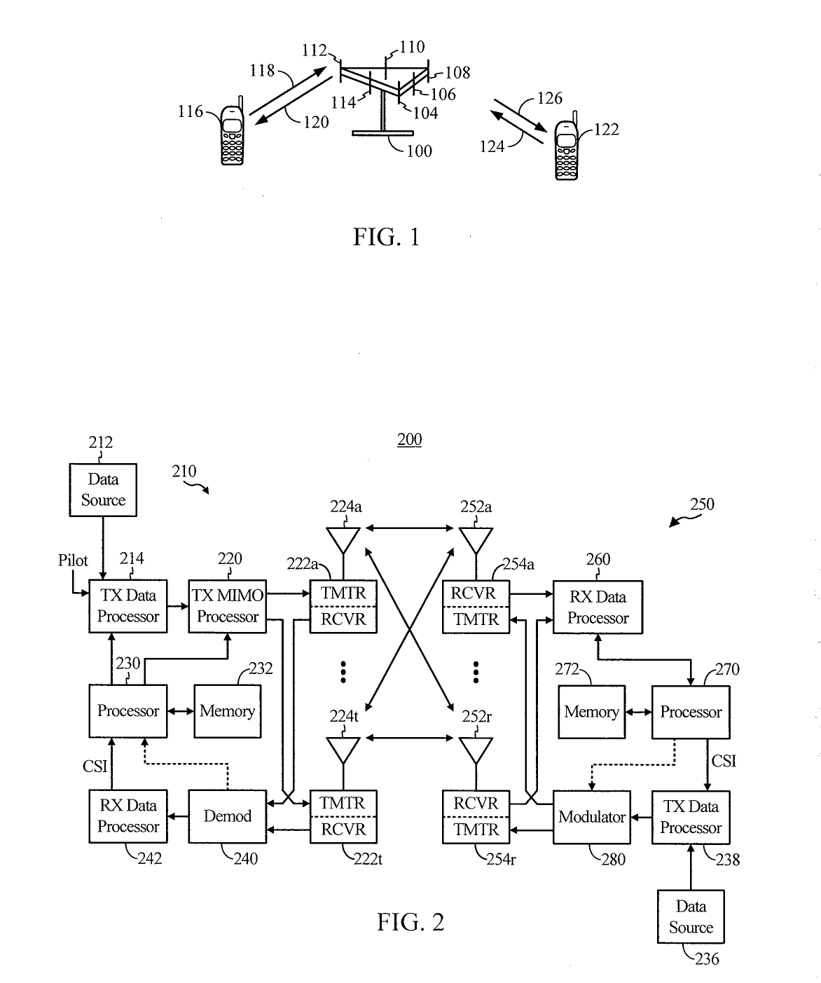

Referring to FIG. 1, a multiple access wireless communication system according to one embodiment is illustrated. An access point 100 (AP) includes multiple antenna groups, one including antenna 104 and antenna 106, another including antenna 108 and antenna 110, and yet another including antenna 112 and antenna 114. In FIG. 1, only two antennas are shown for each antenna group; however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In an FDD system, communication links 118, 120, 124, and 126 may use different frequency for communication. For example, forward link 120 may use a different frequency then that used by reverse link 118.

Each group of antennas and/or the area in which they are designed to communicate is often referred to as a sector of the access point. In the embodiment, antenna groups each are designed to communicate to access terminals in a sector, of the areas covered by access point 100.

In communication over forward links 120 and 126, the transmitting antennas of access point 100 utilize beamforming in order to improve the signal-to-noise ratio (SNR) of forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point (AP) may be a fixed station used for communicating with the terminals and may also be referred to as a base station (BS), a Node B, or some other terminology. An access terminal may also be called a mobile station (MS), user equipment (UE), a wireless communication device, terminal, user terminal (UT), or some other terminology.

FIG. 2 is a block diagram of an embodiment of a transmitter system 210 (also known as an access point) and a receiver system 250 (also known as an access terminal) in a MIMO system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights and then processes the extracted message.

In an aspect, logical channels are classified into Control Channels and Traffic Channels. Logical Control Channels comprise Broadcast Control Channel (BCCH) which is a DL channel for broadcasting system control information. Paging Control Channel (PCCH) is a DL channel that transfers paging information. Multicast Control Channel (MCCH) is a point-to-multipoint DL channel used for transmitting Multimedia Broadcast and Multicast Service (MBMS) scheduling and control information for one or several MTCHs. Generally, after establishing an RRC connection, this channel is only used by UEs that receive MBMS (Note: old MCCH+MSCH). Dedicated Control Channel (DCCH) is a point-to-point bi-directional channel that transmits dedicated control information used by UEs having an RRC connection. In an aspect, Logical Traffic Channels comprise a Dedicated Traffic Channel (DTCH), which is a point-to-point bi-directional channel, dedicated to one UE, for the transfer of user information. Also, a Multicast Traffic Channel (MTCH) is a point-to-multipoint DL channel for transmitting traffic data.

In an aspect, Transport Channels are classified into DL and UL. DL Transport Channels comprise a Broadcast Channel (BCH), Downlink Shared Data Channel (DL-SDCH), and a Paging Channel (PCH), the PCH for support of UE power saving (DRX cycle is indicated by the network to the UE), broadcasted over entire cell and mapped to PHY resources which can be used for other control/traffic channels. The UL Transport Channels comprise a Random Access Channel (RACH), a Scheduling Request (SR), a Physical Uplink Shared Channel (PUSCH), and a plurality of PHY channels. The PHY channels comprise a set of DL channels and UL channels.

In an aspect, a channel structure is provided that preserves low PAR (at any given time, the channel is contiguous or uniformly spaced in frequency) properties of a single carrier waveform.

For the purposes of the present document, the following abbreviations (including abbreviations for various DL and UL PHY Channels) apply:

1×CSFB Circuit Switched Fallback to 1×RTT

ABS Almost Blank Subframe

ACK Acknowledgement

ACLR Adjacent Channel Leakage Ratio

AM Acknowledged Mode

AMBR Aggregate Maximum Bit Rate

ANR Automatic Neighbour Relation

ARQ Automatic Repeat Request

ARP Allocation and Retention Priority

AS Access Stratum

BCCH Broadcast Control Channel

BCH Broadcast Channel

BSR Buffer Status Report

C/I Carrier-to-Interference Power Ratio

CAZAC Constant Amplitude Zero Auto-Correlation

CA Carrier Aggregation

CBC Cell Broadcast Center

CC Component Carrier

CIF Carrier Indicator Field

CMAS Commercial Mobile Alert Service

CMC Connection Mobility Control

CP Cyclic Prefix

C-plane Control Plane

C-RNTI Cell RNTI

CQI Channel Quality Indicator

CRC Cyclic Redundancy Check

CSA Common Subframe Allocation

CSG Closed Subscriber Group

DCCH Dedicated Control Channel

DeNB Donor eNB

DFTS DFT Spread OFDM

DL Downlink

DRB Data Radio Bearer

DRX Discontinuous Reception

DTCH Dedicated Traffic Channel

DTX Discontinuous Transmission

DwPTS Downlink Pilot Time Slot

ECGI E-UTRAN Cell Global Identifier

ECM EPS Connection Management

EMM EPS Mobility Management

E-CID Enhanced Cell-ID (positioning method)

eNB E-UTRAN NodeB

EPC Evolved Packet Core

EPS Evolved Packet System

E-RAB E-UTRAN Radio Access Bearer

ETWS Earthquake and Tsunami Warning System

E-UTRA Evolved UTRA

E-UTRAN Evolved UTRAN

FDD Frequency Division Duplex

FDM Frequency Division Multiplexing

GERAN GSM EDGE Radio Access Network

GNSS Global Navigation Satellite System

GSM Global System for Mobile communication

GBR Guaranteed Bit Rate

GP Guard Period

HARQ Hybrid ARQ

HO Handover

HRPD High Rate Packet Data

HSDPA High Speed Downlink Packet Access

ICIC Inter-Cell Interference Coordination

IP Internet Protocol

LB Load Balancing

LCG Logical Channel Group

LCR Low Chip Rate

LCS LoCation Service

LIPA Local IP Access

LPPa LTE Positioning Protocol Annex

L-GW Local Gateway

LTE Long Term Evolution

MAC Medium Access Control

MBMS Multimedia Broadcast Multicast Service

MBR Maximum Bit Rate

MBSFN Multimedia Broadcast multicast service Single Frequency

Network

MCCH Multicast Control Channel

MCE Multi-cell/multicast Coordination Entity

MCH Multicast Channel

MCS Modulation and Coding Scheme

MDT Minimization of Drive Tests

MIB Master Information Block

MIMO Multiple Input Multiple Output

MME Mobility Management Entity

MSA MCH Subframe Allocation

MSI MCH Scheduling Information

MSP MCH Scheduling Period

MTCH Multicast Traffic Channel

NACK Negative Acknowledgement

NAS Non-Access Stratum

NCC Next Hop Chaining Counter

NH Next Hop key

NNSF NAS Node Selection Function

NR Neighbour cell Relation

NRT Neighbour Relation Table

OFDM Orthogonal Frequency Division Multiplexing

OFDMA Orthogonal Frequency Division Multiple Access

OTDOA Observed Time Difference Of Arrival (positioning method)

P-GW PDN Gateway

P-RNTI Paging RNTI

PA Power Amplifier

PAPR Peak-to-Average Power Ratio

PBCH Physical Broadcast CHannel

PBR Prioritised Bit Rate

PCC Primary Component Carrier

PCCH Paging Control Channel

PCell Primary Cell

PCFICH Physical Control Format Indicator CHannel

PCH Paging Channel

PCI Physical Cell Identifier

PDCCH Physical Downlink Control CHannel

PDSCH Physical Downlink Shared CHannel

PDCP Packet Data Convergence Protocol

PDN Packet Data Network

PDU Protocol Data Unit

PHICH Physical Hybrid ARQ Indicator CHannel

PHY Physical layer

PLMN Public Land Mobile Network

PMCH Physical Multicast CHannel

PRACH Physical Random Access CHannel

PRB Physical Resource Block

PSC Packet Scheduling

PUCCH Physical Uplink Control CHannel

PUSCH Physical Uplink Shared CHannel

PWS Public Warning System

QAM Quadrature Amplitude Modulation

QCI QoS Class Identifier

QoS Quality of Service

RA-RNTI Random Access RNTI

RAC Radio Admission Control

RACH Random Access Channel

RAT Radio Access Technology

RB Radio Bearer

RBC Radio Bearer Control

RF Radio Frequency

RIM RAN Information Management

RLC Radio Link Control

RN Relay Node

RNC Radio Network Controller

RNL Radio Network Layer

RNTI Radio Network Temporary Identifier

ROHC Robust Header Compression

RRC Radio Resource Control

RRM Radio Resource Management

RU Resource Unit

S-GW Serving Gateway

S1-MME S1 for the control plane

SCC Secondary Component Carrier

SCell Secondary Cell

SI System Information

SIB System Information Block

SI-RNTI System Information RNTI

S1-U S1 for the user plane

SAE System Architecture Evolution

SAP Service Access Point

SC-FDMA Single Carrier-Frequency Division Multiple Access

SCH Synchronization Channel

SDF Service Data Flow

SDMA Spatial Division Multiple Access

SDU Service Data Unit

SeGW Security Gateway

SFN System Frame Number

SPID Subscriber Profile ID for RAT/Frequency Priority

SR Scheduling Request

SRB Signalling Radio Bearer

SU Scheduling Unit

TA Tracking Area

TB Transport Block

TCP Transmission Control Protocol

TDD Time Division Duplex

TEID Tunnel Endpoint Identifier

TFT Traffic Flow Template

TM Transparent Mode

TNL Transport Network Layer

TTI Transmission Time Interval

UE User Equipment

UL Uplink

UM Unacknowledged Mode

UMTS Universal Mobile Telecommunication System

U-plane User plane

UTRA Universal Terrestrial Radio Access

UTRAN Universal Terrestrial Radio Access Network

UpPTS Uplink Pilot Time Slot

VRB Virtual Resource Block

X2-C X2-Control plane

X2-U X2-User plane

### AN EXAMPLE RELAY SYSTEM

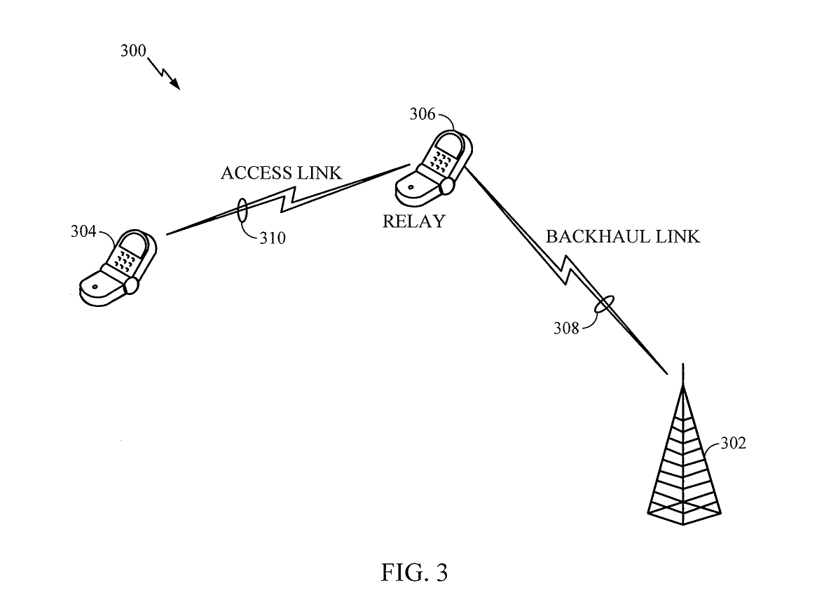

FIG. 3 illustrates an example wireless system 300 in which certain aspects of the present disclosure may be practiced. As illustrated, the system 300 includes a donor base station (BS) 302 (also known as donor access point or a donor evolved Node B (DeNB)) that communicates with a user equipment (UE) 304 via a relay node 306 (also known as a relay station or a relay). While the relay node 306 may comprise a relay base station (also known as a relay eNB), a UE (e.g., a cell phone) may also function as a relay for relaying transmissions for other UEs, as shown in FIG. 3. Such relays may be known as relay UEs, UE relays, or UEs functioning as relays.

The relay node 306 may communicate with the donor BS 302 via a backhaul link 308 and with the UE 304 via an access link 310. In other words, the relay node 306 may receive downlink messages from the donor BS 302 over the backhaul link 308 and relay these messages to the UE 304 over the access link 310. Similarly, the relay node 306 may receive uplink messages from the UE 304 over the access link 310 and relay these messages to the donor BS 302 over the backhaul link 308. In this manner, the relay node 306 may, thus, be used to supplement a coverage area and help fill “coverage holes.”

### EXAMPLE POWER/COMPLEXITY REDUCTION TECHNIQUES FOR L2 UE RELAYS

Introduction: UE Relay Types and Modes

As noted above, while aspects of the present disclosure may be utilized to particular advantage with out-of-band relays with backhaul hops on licensed spectrum and access hops on unlicensed spectrum (e.g., the television white space or TVWS spectrum), the techniques presented herein may be easily extended to in-band/out-of-band relays using licensed LTE spectrum for both backhaul and access hops, as well as to UE Relays with non-LTE backhaul (including wired backhauls).

In general, UE relays may be considered as falling into two defined classes: (1) power-constrained (e.g., battery-operated) UE relays and (2) power-unconstrained (e.g., wall-connected) UE relays. Techniques utilized by each may differ based on their different needs to conserve power.

For example, power-unconstrained UE relays may operate in an “always-on” fashion on the access hop, whether or not such UE relays are currently serving any terminal UEs on the access hop. However, these UE relays may go into discontinuous reception (DRX) or another power-saving mode on the backhaul hop. Basically, power-unconstrained UE relays may be intended to be capable of serving legacy UEs (e.g., UEs that operate according to a previous version of a standard as contrasted with “non-legacy” UEs capable of operating with later versions of a standard) that have RF support to operate the access-hop spectrum.

On the other hand, power-constrained UE relays may operate in a newly defined power-saving mode when such UE relays are idle on the access hop, while these UE relays behave like regular eNBs when they are active on the access hop. A power-constrained UE relay may switch from active mode to idle mode (standby mode) when the UE relay is no longer serving any terminal UEs and may switch from idle mode to active mode when the UE relay detects an access attempt by a terminal UE. Of course, in order to operate in either of these two modes, the network or donor eNB (DeNB) typically must authorize the UE relay to serve other terminal UEs, and the UE relay generally must have adequate capacity on its backhaul.

Certain aspects of the present disclosure may be used to particular advantage with power-constrained UE relays, whether these UE relays are idle or active on the access hop. It is to be understood that power-unconstrained UE relays may behave just like power-constrained UE relays that are always in active mode on the access hop. As noted before, an advantage of power-unconstrained UE relays is that they are able to serve so called legacy LTE UEs that are capable of operating in the access-hop spectrum (from the RF perspective).

Out-of-Band Beacons

Each type of UE relay (power-constrained or otherwise, active or idle on the access-hop) may transmit an out-of-band beacon on zero or more “rendezvous” channels that are designated by the operator(s) and well-known to the terminal UEs. One of these rendezvous channels may coincide with the licensed channel used for the backhaul hop of the UE relay. In some cases, terminal UEs may be made aware of rendezvous channels, for example, via broadcast signaling or other type of signaling.

In addition to out-of-band beacons, UE relays that are idle on the access hop may transmit in-band beacons on their access-hop spectrum, while UE relays that are active on the access hop may transmit their regular broadcast signals (e.g., Primary Synchronization Signal (PSS), Secondary Synchronization Signal (SSS), Physical Broadcast Channel (PBCH), System Information Block (SIB), etc.).

The purpose of the out-of-band beacons may be to reduce the search complexity for terminal UEs looking for UE relays. These beacons may be used for discovery and (relatively) coarse timing/frequency acquisition of the UE relays by the access UEs (as well as by other UE relays for access-hop channel-selection purposes). Hence, an out-of-band beacon may be based on a proximity detection signal (PDS)-like design (maybe even a PUSCH-like waveform that uses just half of a resource block (RB)). As used herein, the term PDS generally refers to a special signature sequence known at a receiver that is transmitted relatively infrequently by a transmitter.

The transmit power of the out-of-band beacon may be different from the beacon's transmit power on its access hop, possibly to provide for any best-effort compensation for the expected path-loss differential between the rendezvous frequency and the access-hop frequency.

In addition to UE reference signals (RSs), the out-of-band beacon may contain a PUSCH-like transmission which is used to carry a payload with one or more of the following pieces of information: (1) a pointer to the frequency used for the access-hop; (2) optionally, the physical cell identifier (PCI) selected by the UE relay for its access hop; and (3) the time offset between the out-of-band beacon transmission on the rendezvous channel and the in-band beacon transmission. These parameters may be any suitable size and format, for example, approximately 16 bits for the pointer to the access-hop frequency and/or 10 bits for the UE relay PCI. In some cases, the out-of-band beacon may indicate the periodicity in the case of a UE relay that is idle on the access hop, or for other aspects, the time offset between the out-of-band beacon transmission on the rendezvous channel and the super-frame boundary on the access-hop frequency, in the case of a UE relay that is active on the access hop (which may be approximately 16 bits). Assuming 16 bits or less for three parameters implies less than 48 bits of payload overall, which may fit in half of an RB.

Each DeNB may designate certain subframes for out-of-band beacons. For example, a DeNB may designate 1 in every N subframes, with N being a relatively large number (e.g., on the order of 1000) for out-of-band beacons. Different rendezvous channels may use different subframes for out-of-band beacon transmissions (e.g., in an effort to ease RF requirements on the UE relays, albeit possibly at the expense of battery life-as a UE would have to scan more subframes to detect a relay).

Among these so-called “beacon subframes,” each UE relay may pick 1 out of M beacon subframes, as well as a PDS resource (e.g., 1 RB or half an RB) to transmit the UE relay's out-of-band beacons during the selected beacon subframes. The selection of beacon subframes and a PDS resource by a given UE relay may be random or based on a listen-and-pick scheme. In a synchronous LTE network, adjacent DeNBs may designate the same subset of subframes for out-of-beacon transmissions on a given rendezvous channel, in an effort to facilitate search performance at the terminal UEs.

In-Band Beacons

According to certain aspects, a UE relay that is idle on the access hop may transmit an in-band beacon on the frequency the UE relay has chosen for its access hop. The purpose of the in-band beacon may be to enable fine timing and frequency acquisition by the terminal UEs, as well as the system parameters governing the UE relay operation. Other UE relays may also use these beacons, for example, for access-hop channel selection and interference coordination purposes.

According to certain aspects, the in-band beacon may consist of the LTE broadcast channels (e.g., PSS, SSS, PBCH, and/or SIBs) that are transmitted at low duty cycle (as indicated in the out-of-band beacon payload). In fact, an LTE broadcast channel may be considered (for the most part) a special case of an out-of-band beacon payload, which is transmitted with the duty cycle mandated by the current LTE specification.

Note that the SIBs contained in the in-band beacon may include the cell global identification (CGI) of the UE relay, which may be used to uniquely identify the UE relay for interference management and mobility purposes (e.g., in a closed subscriber group (CSG)).

In addition, when the UE relay is actually idle on the access hop, the UE relay may specify low duty cycle random access channel (RACH) configuration (perhaps lower duty cycle than what is current in the standard), which may be used by a terminal UE to access the UE relay, and also to trigger the transmission of the UE relay from idle mode to active mode on the access hop.

Waveform Choice for the Two Beacon Types

As noted above, a PDS-like solution may be chosen for out-of-band beacons, but the legacy broadcast channel for in-band beacons. This PDS-based solution may be well-suited to carry small payloads by a large number of nodes using a small fraction of signal resources. This may be important for out-of-band beacons, which may support UE relays operating on a possibly large number of distinct access frequencies/bands to advertise their presence on a common rendezvous channel. On the other hand, the PDS-based waveform only provides coarse timing/frequency reference to the receivers, which may most likely be sufficient for UE relay discovery.

By contrast, a PSS-/SSS-/PBCH-based solution may provide finer timing/frequency reference, as well as the ability to carry larger amounts of payload (multiple SIBs) in a legacy-compatible manner. Both of these are desirable features for these in-band beacons, as well as for the regular broadcast channels.

### EXAMPLE BEACONS FOR UE RELAYS

To benefit from UE relays, a terminal UE may first have to detect the presence of any UE relays in the vicinity of the terminal UE. Furthermore, if UE relays transmit on different frequencies, inter-frequency measurements may be involved. Such inter-frequency measurements may require a terminal UE to request measurement gaps, which can be wasteful, as the terminal UE performs inter-frequency measurements and then send reports to the network.

Accordingly, improved techniques for detecting the presence of UE relays are desirable. Ideally, such techniques would reduce or eliminate inter-frequency measurements.

For certain aspects of the present disclosure, an evolved Node B (eNB) may indicate to a terminal UE which frequencies to monitor for detection of relay UEs. For other aspects, a UE relay may send a beacon, which may have a physical (PHY) layer pattern.

Reserved PCIs

One solution for detecting UE relays may involve reserving a number of physical cell identifiers (PCIs) for use by UE relays. For example, UE relays may transmit synchronization signals (e.g., PSS/SSS and potentially PBCH) using these reserved PCIs on a first carrier frequency (f1), the same carrier frequency on which the macro eNB transmits. In this manner, selecting one of these reserved PCIs may provide an indication to a terminal UE a transmitting UE is a UE functioning as a relay. Thus, detecting one of the reserved PCIs by a terminal UE may indicate the proximity of a UE relay. The terminal UE may still request a measurement gap to the eNB in order to perform an inter-frequency measurement where the UE relay may transmit data traffic-but only after detecting a relay UE, rather than using the measurement gap to search for and detect relay UEs.

According to certain aspects, the synchronization signals (e.g., PSS/SSS) may contain an explicit carrier frequency indication (e.g., indicating a second carrier frequency f2) where the terminal UE should search for UE relays. Alternatively, a carrier frequency indication may be conveyed with PBCH or configured by the eNB via Radio Resource Control (RRC) messaging (dedicated or broadcast).

Reserved Subframes

As noted above, according to certain aspects, PSS/SSS/PBCH may be transmitted on carrier frequency f1 in a limited number of reserved subframes. In this case, the periodicity of the PSS/SSS/PBCH may be different from the current LTE standard (i.e., 5/10 ms). For example, in order to save on battery consumption of UE relays, the periodicity may be extended to hundreds of milliseconds (as opposed to current 5/10 ms periodicity) or even several seconds.

In some cases, this periodicity may be directly signaled by the eNB (via dedicated or broadcast messaging) or signaled by the UE relay on f1 inside PBCH, for example. According to certain aspects, PBCH may also carry other useful information, such as the PSS/SSS signature sequence utilized by the UE relay at f2. For certain aspects, the periodicity may be reduced on both f1 and f2.

The location of the reserved (or designated) subframes may be explicitly signaled or configured by the eNB. The terminal UEs may be configured to search for UE relays only at those designated subframes.

According to certain aspects, UE relay measurements may be performed on a restricted set of subframes. In other words, only a restricted set of subframes may be suitable for UE relay measurements, as the UE relays may not be transmitting common reference signals (CRSs) or other signals utilized for Radio Resource Management (RRM) measurements in each subframe.

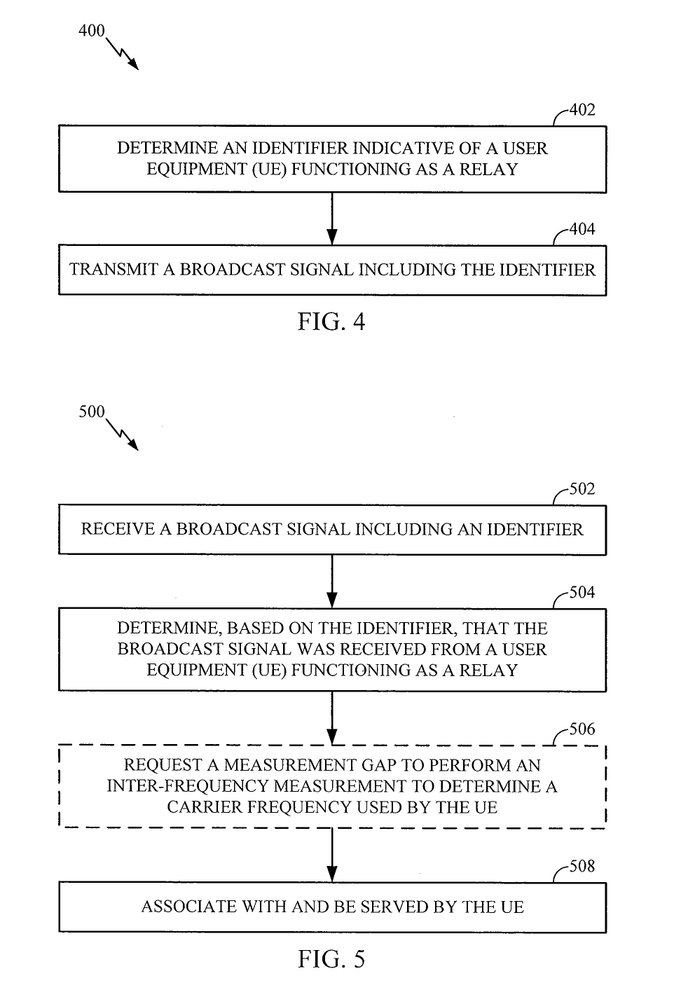

FIG. 4 is a flow diagram of example operations 400 for broadcasting an identifier indicative of a UE functioning as a relay. The operations 400 may be performed by a UE functioning as a relay (i.e., a UE relay).

At 402, the UE may determine an identifier indicative of a UE functioning as a relay. As noted above, according to certain aspects, the identifier may comprise a PCI selected from a set of PCIs reserved for UE relays.

At 404, the UE may transmit a broadcast signal including the identifier. The broadcast signal may comprise at least one of a primary synchronization signal (PSS), a secondary synchronization signal (SSS), or a physical broadcast channel (PBCH). A terminal UE detecting the broadcast signal may detect the proximity of the relay UE, on the basis of the included identifier (e.g., reserved PCI).

FIG. 5 is a flow diagram of example operations 500 for detecting a UE functioning as a relay based on an identifier in a broadcast signal. In other words, the operations 500 may be performed by a terminal UE to detect proximity of a relay UE performing operations shown in FIG. 4.

At 502, the terminal UE may receive a broadcast signal including an identifier. The identifier may comprise a PCI as described above. The terminal UE may determine, at 504 based on the identifier, that the broadcast signal was received from a UE functioning as a relay (i.e., a UE relay).

For certain aspects, the terminal UE may optionally request a measurement gap to perform an inter-frequency measurement to determine a carrier frequency used by the UE relay at 506. At 508, the terminal UE may associate with and be served by the UE relay.

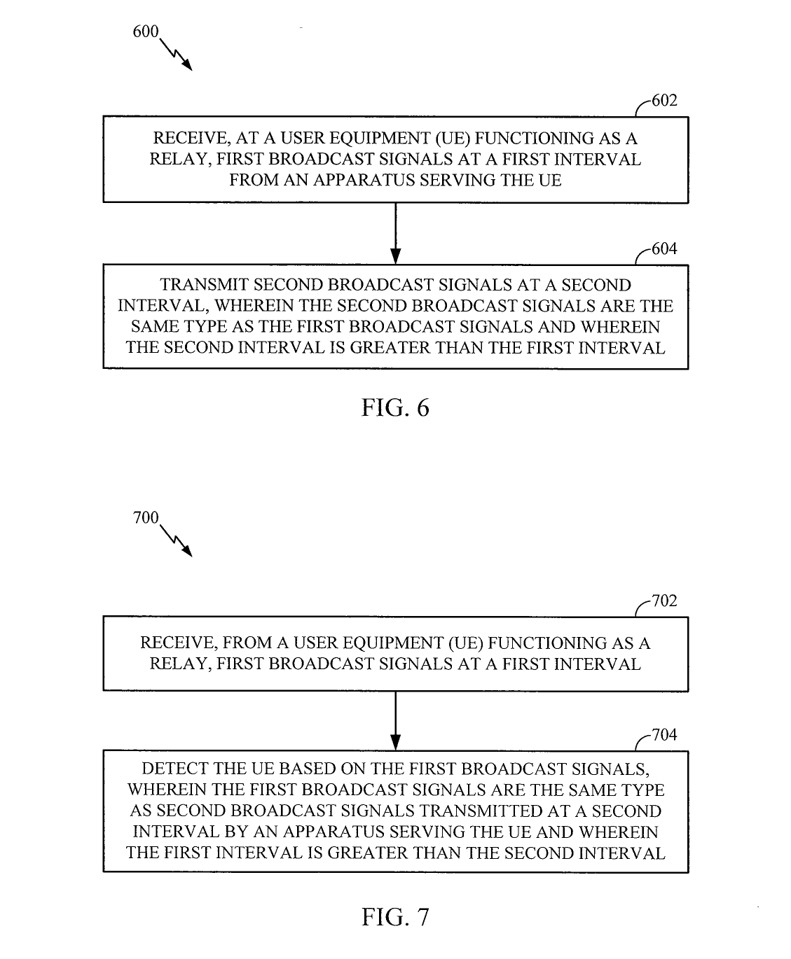

FIG. 6 is a flow diagram of example operations 600 for transmitting broadcast signals with a greater interval than received broadcast signals of the same type. The operations 600 may be performed by a UE functioning as a relay (i.e., a UE relay). At 602, the UE may receive first broadcast signals at a first interval from an apparatus (e.g., an eNB) serving the UE.

At 604, the UE may transmit second broadcast signals at a second interval. The second broadcast signals may be the same type as the first broadcast signals, and the second interval may be greater than the first interval. For certain aspects, the second broadcast signals may be transmitted in subframes designated for other UEs to detect the presence of the UE. The first and second broadcast signals may comprise primary synchronization signals (PSSs), secondary synchronization signals (SSSs), or physical broadcast channels (PBCHs). For certain aspects, the first interval is about 5 ms (e.g., as in LTE) and the second interval is at least 100 ms or at least 1 s.

FIG. 7 is a flow diagram of example operations 700 for detecting a UE functioning as a relay based on broadcast signals with a greater interval than broadcast signals of the same type transmitted by an apparatus serving the UE functioning as a relay (i.e., a UE relay). The operations 700 may be performed by a terminal UE, for example.

At 702, the terminal UE may receive, from a UE functioning as a relay, first broadcast signals at a first interval. At 704, the terminal UE may detect the UE relay based on the first broadcast signals. The first broadcast signals may be the same type as second broadcast signals transmitted at a second interval by an apparatus serving the UE. The first interval may be greater than the second interval.

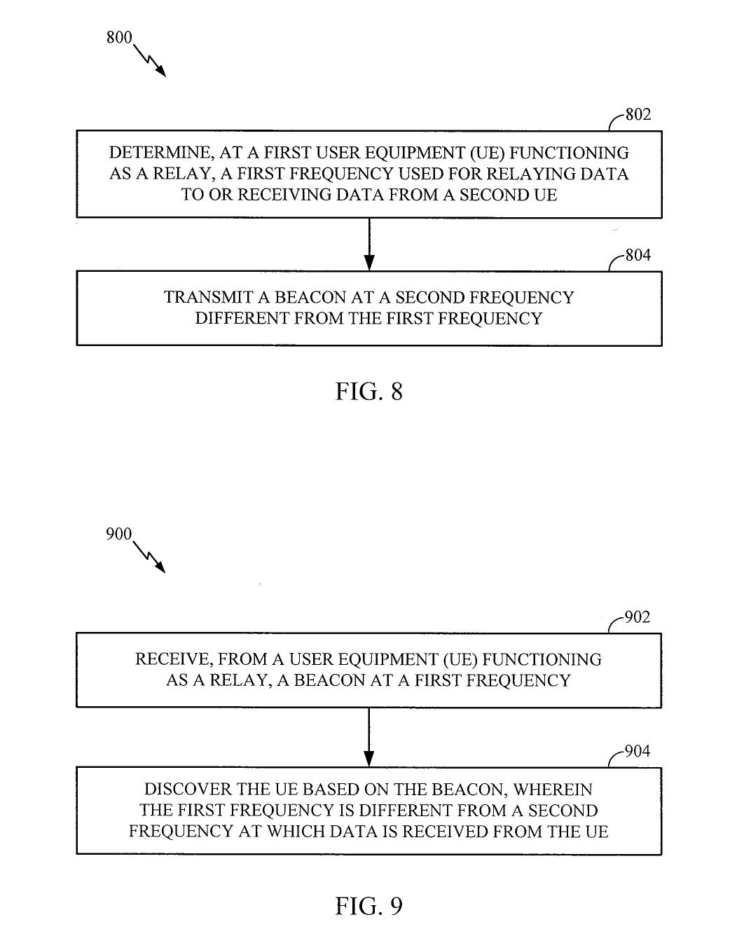

FIG. 8 is a flow diagram of example operations 800 for transmitting an out-of-band beacon. The operations 800 may be performed by a first UE functioning as a relay, for example.

At 802, the first UE may determine a first frequency used for relaying data to or receiving data from a second UE. At 804, the first UE may transmit a beacon at a second frequency different from the first frequency. For certain aspects, the beacon may be an out-of-band beacon.

For certain aspects, transmitting the beacon at 804 may comprise transmitting the beacon on one or more rendezvous channels as described above. The first frequency may comprise an access-hop frequency, and the second frequency may comprise a rendezvous frequency. For certain aspects, the rendezvous frequency is in an unlicensed frequency band. One of the rendezvous channels may coincide with a licensed channel for a backhaul hop used in communicating with an apparatus (e.g., an eNB).

For certain aspects, the beacon may provide an indication of the first frequency. The beacon may also comprise an identifier indicative of the first UE, such as a physical cell identifier (PCI) selected by the first UE. The beacon may also comprise an indication of a time offset between transmission of the beacon and transmission of another beacon at the first frequency.

FIG. 9 is a flow diagram of example operations 900 for discovering a UE functioning as a relay based on an out-of-band beacon. The operations 900 may be performed by a terminal UE, for example.

At 902, the terminal UE may receive, from a UE functioning as a relay (i.e., a UE relay), a beacon at a first frequency. At 904, the terminal UE may discover the UE based on the beacon, wherein the first frequency is different from a second frequency at which data is received from the UE.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may have corresponding counterpart means-plus-function components with similar numbering.

For example, means for transmitting or means for requesting may comprise a transmitter (e.g., a transmitter 222) and/or an antenna 224 of the transmitter system 210 or a transmitter (e.g., a transmitter 254) and/or an antenna 252 of the receiver system 250 illustrated in FIG. 2. Means for receiving or means for listening may comprise a receiver (e.g., a receiver 254) and/or an antenna 252 of the receiver system 250 or a receiver (e.g., a receiver 222) and/or an antenna 224 of the transmitter system 210 illustrated in FIG. 2. Means for processing, means for determining, means for measuring, means for performing, means for making aware, means for associating with and being served, means for discovering, or means for detecting may comprise a processing system, which may include at least one processor, such as the RX data processor 260, the processor 270, and/or the TX data processor 238 of the receiver system 250 or the RX data processor 242, the processor 230, and/or the TX data processor 214 of the transmitter system 210 illustrated in FIG. 2.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for wireless communications, comprising:
determining an identifier indicative of a user equipment (UE) functioning as a relay, wherein the identifier comprises a physical cell identifier (PCI) wherein the determining comprises selecting the PCI from a plurality of reserved PCIs for indicating the UE is functioning as a relay; and
transmitting a broadcast signal including the identifier.

2. The method of claim 1, wherein the broadcast signal comprises at least one of a primary synchronization signal (PSS), a secondary synchronization signal (SSS), or a physical broadcast channel (PBCH).

3. The method of claim 1, wherein the broadcast signal comprises an indication of a carrier frequency used by the UE functioning as a relay.

4. The method of claim 3, wherein the carrier frequency is in an unlicensed frequency band.

5. The method of claim 1, wherein the transmitting comprises transmitting the broadcast signal at a carrier frequency used by an apparatus serving the UE functioning as a relay.

6. A method for wireless communications, comprising:
receiving a broadcast signal including an identifier, wherein the identifier comprises a physical cell identifier (PCI) wherein the determining comprises selecting the PCI from a plurality of reserved PCIs for indicating the UE is functioning as a relay; and
based on the identifier, determining that the broadcast signal was received from a user equipment (UE) functioning as a relay.

7. The method of claim 6, wherein the broadcast signal comprises at least one of a primary synchronization signal (PSS), a secondary synchronization signal (SSS), or a physical broadcast channel (PBCH).

8. The method of claim 6, wherein the broadcast signal comprises an indication of a carrier frequency used by the UE functioning as a relay on an access link.

9. The method of claim 8, wherein the carrier frequency is in an unlicensed frequency band.

10. The method of claim 6, further comprising receiving, from an apparatus, a message indicating a carrier frequency used by the UE functioning as a relay.

11. The method of claim 10, wherein the message comprises a dedicated or a broadcast radio resource control (RRC) message.

12. The method of claim 6, further comprising associating with and being served by the UE functioning as a relay.

13. The method of claim 6, further comprising requesting a measurement gap to perform an inter-frequency measurement to determine a carrier frequency used by the UE functioning as a relay.

14. A method for wireless communications, comprising:
receiving, at a user equipment (UE) functioning as a relay, first broadcast signals at a first interval from an apparatus serving the UE functioning as a relay; and
transmitting second broadcast signals at a second interval, wherein the second broadcast signals are the same type as the first broadcast signals and wherein the second interval is greater than the first interval.

15. The method of claim 14, wherein the second broadcast signals are transmitted in subframes designated for terminal UEs to detect a presence of UEs functioning as relays.

16. The method of claim 14, wherein:
the second broadcast signals are transmitted on a first carrier frequency; and
the second broadcast signals comprises a physical broadcast channel (PBCH) indicating at least one: of a second carrier frequency a terminal UE should search for UEs functioning as relays or a synchronization signal signature sequence used by the UE functioning as a relay on the second carrier frequency.

17. The method of claim 14, wherein the transmitting comprises transmitting the second broadcast signals at a carrier frequency used by the apparatus serving the UE functioning as a relay.

18. The method of claim 14, wherein the second broadcast signals comprise an indication of a carrier frequency used by the UE functioning as a relay.

19. The method of claim 18, wherein the carrier frequency is in an unlicensed frequency band.

20. The method of claim 14, wherein the first interval is 5 ms and the second interval is at least 100 ms.

21. The method of claim 20, wherein the second interval is at least 1 s.

22. A method for wireless communications, comprising:
receiving, from a user equipment (UE) functioning as a relay, first broadcast signals at a first interval; and
detecting the UE functioning as a relay based on the first broadcast signals, wherein the first broadcast signals are the same type as second broadcast signals transmitted at a second interval by an apparatus serving the UE functioning as a relay and wherein the first interval is greater than the second interval.

23. The method of claim 22, wherein the first broadcast signals are received in designated subframes for terminal UEs to detect a presence of the UE functioning as a relay.

24. The method of claim 23, further comprising receiving an indication of the designated subframes from the apparatus.

25. The method of claim 24, further comprising listening for the first broadcast signals from the UE functioning as a relay only during the designated subframes according to the indication.

26. The method of claim 23, further comprising performing one or more measurements of other signals in the designated subframes.

27. The method of claim 26, further comprising associating with the UE functioning as a relay based on the measurements.

28. The method of claim 27, wherein the first and second broadcast signals comprise primary synchronization signals (PSSs), secondary synchronization signals (SSSs), or physical broadcast channels (PBCHs).

29. The method of claim 23, wherein the receiving comprises receiving the first broadcast signals at a carrier frequency used by the apparatus serving the UE functioning as a relay.

30. The method of claim 23, wherein the first broadcast signals comprise an indication of a carrier frequency used by the UE functioning as a relay.

31. The method of claim 30, wherein the carrier frequency is in an unlicensed frequency band.

32. A method for wireless communications, comprising:
determining, at a first user equipment (UE) functioning as a relay, a first frequency used for relaying data to or receiving data from a terminal UE; and
transmitting a beacon at a second frequency different from the first frequency.

33. The method of claim 32, wherein the transmitting comprises transmitting the beacon on one or more rendezvous channels.

34. The method of claim 33, wherein the first frequency comprises an access-hop frequency and the second frequency comprises a rendezvous frequency.

35. The method of claim 33, wherein the rendezvous frequency is in an unlicensed frequency band.

36. The method of claim 33, wherein one of the rendezvous channels coincides with a licensed channel for a backhaul hop used in communicating with an apparatus.

37. The method of claim 36, wherein the apparatus comprises an evolved Node B (eNB).

38. The method of claim 32, wherein the beacon comprises an indication of the first frequency.

39. The method of claim 32, wherein the beacon comprises an identifier indicative of the UE functioning as a relay.

40. The method of claim 39, wherein the identifier comprises a physical cell identifier (PCI) selected by the UE functioning as a relay.

41. The method of claim 32, wherein the beacon comprises an indication of a time offset between transmission of the beacon and transmission of another beacon at the first frequency.

42. A method for wireless communications, comprising:
receiving, from a user equipment (UE) functioning as a relay, a beacon at a first frequency; and
discovering the UE functioning as a relay based on the beacon, wherein the first frequency is different from a second frequency at which data is received from the UE.

43. The method of claim 42, wherein the receiving comprises receiving the beacon on one or more rendezvous channels.

44. The method of claim 43, wherein the second frequency comprises an access-hop frequency and the first frequency comprises a rendezvous frequency.

45. The method of claim 44, wherein the rendezvous frequency is in an unlicensed frequency band.

46. The method of claim 43, further comprising being made aware of rendezvous channels.

47. The method of claim 42, wherein the beacon comprises an indication of the second frequency.

48. The method of claim 42, wherein the beacon comprises an identifier indicative of the UE functioning as a relay.

49. The method of claim 48, wherein the identifier comprises a physical cell identifier (PCI) selected by the UE functioning as a relay.

50. The method of claim 42, wherein the beacon comprises an indication of a time offset between transmission of the beacon and transmission of another beacon at the second frequency.

51. An apparatus for wireless communications, comprising:
means for determining an identifier indicative of a user equipment (UE) functioning as a relay, wherein the identifier comprises a physical cell identifier (PCI) wherein the determining comprises selecting the PCI from a plurality of reserved PCIs for indicating the UE is functioning as a relay; and
means for transmitting a broadcast signal including the identifier.

52. The apparatus of claim 1, wherein the broadcast signal comprises an indication of a carrier frequency used by the UE functioning as a relay.

53. The apparatus of claim 52, wherein the carrier frequency is in an unlicensed frequency band.

54. An apparatus for wireless communications, comprising:
means for receiving a broadcast signal including an identifier, wherein the identifier comprises a physical cell identifier (PCI) wherein the determining comprises selecting the PCI from a plurality of reserved PCIs for indicating the UE is functioning as a relay; and
means for determining, based on the identifier, that the broadcast signal was received from a user equipment (UE) functioning as a relay.

55. The apparatus of claim 54, wherein the broadcast signal comprises an indication of a carrier frequency used by the UE functioning as a relay on an access link.

56. The apparatus of claim 55, wherein the carrier frequency is in an unlicensed frequency band.

57. The apparatus of claim 54, further comprising means for requesting a measurement gap to perform an inter-frequency measurement to determine a carrier frequency used by the UE functioning as a relay.

58. An apparatus for wireless communications, comprising:
means for receiving, at a user equipment (UE) functioning as a relay, first broadcast signals at a first interval from an apparatus serving the UE functioning as a relay; and
means for transmitting second broadcast signals at a second interval, wherein the second broadcast signals are the same type as the first broadcast signals and wherein the second interval is greater than the first interval.

59. The apparatus of claim 58, wherein the second broadcast signals are transmitted in subframes designated for terminal UEs to detect a presence of UEs functioning as relays.

60. The apparatus of claim 58, wherein:
the second broadcast signals are transmitted on a first carrier frequency; and
the second broadcast signals comprises a physical broadcast channel (PBCH) indicating at least one: of a second carrier frequency a terminal UE should search for UEs functioning as relays or a synchronization signal signature sequence used by the UE functioning as a relay on the second carrier frequency.

61. The apparatus of claim 58, wherein the second broadcast signals comprise an indication of a carrier frequency used by the UE functioning as a relay.

62. The apparatus of claim 61, wherein the carrier frequency is in an unlicensed frequency band.

63. An apparatus for wireless communications, comprising:
means for receiving, from a user equipment (UE) functioning as a relay, first broadcast signals at a first interval; and
means for detecting the UE functioning as a relay based on the first broadcast signals, wherein the first broadcast signals are the same type as second broadcast signals transmitted at a second interval by an apparatus serving the UE functioning as a relay and wherein the first interval is greater than the second interval.

64. The apparatus of claim 63, wherein the first broadcast signals are received in designated subframes for terminal UEs to detect a presence of the UE functioning as a relay.

65. The apparatus of claim 64, further comprising means for receiving an indication of the designated subframes from the apparatus.

66. The apparatus of claim 64, further comprising means for performing one or more measurements of other signals in the designated subframes.

67. The apparatus of claim 64, wherein the first broadcast signals comprise an indication of a carrier frequency used by the UE functioning as a relay.

68. The apparatus of claim 67, wherein the carrier frequency is in an unlicensed frequency band.

69. An apparatus for wireless communications, comprising:
means for determining, at a first user equipment (UE) functioning as a relay, a first frequency used for relaying data to or receiving data from a terminal UE; and
means for transmitting a beacon at a second frequency different from the first frequency.

70. The apparatus of claim 69, wherein the means for transmitting comprises means for transmitting the beacon on one or more rendezvous channels.

71. The apparatus of claim 70, wherein the first frequency comprises an access-hop frequency and the second frequency comprises a rendezvous frequency.

72. The apparatus of claim 70, wherein the rendezvous frequency is in an unlicensed frequency band.

73. The apparatus of claim 70, wherein one of the rendezvous channels coincides with a licensed channel for a backhaul hop used in communicating with an apparatus.

74. The apparatus of claim 69, wherein the beacon comprises an indication of the first frequency.

75. The apparatus of claim 69, wherein the beacon comprises an indication of a time offset between transmission of the beacon and transmission of another beacon at the first frequency.

76. A apparatus for wireless communications, comprising:
means for receiving, from a user equipment (UE) functioning as a relay, a beacon at a first frequency; and
means for discovering the UE functioning as a relay based on the beacon, wherein the first frequency is different from a second frequency at which data is received from the UE.

77. The apparatus of claim 76, wherein the means for receiving comprises means for receiving the beacon on one or more rendezvous channels.

78. The apparatus of claim 77, wherein the second frequency comprises an access-hop frequency and the first frequency comprises a rendezvous frequency.

79. The apparatus of claim 78, wherein the rendezvous frequency is in an unlicensed frequency band.

80. The apparatus of claim 76, wherein the beacon comprises an indication of the second frequency.

81. The apparatus of claim 76, wherein the beacon comprises an indication of a time offset between transmission of the beacon and transmission of another beacon at the second frequency.

82. An apparatus for wireless communications, comprising:
at least one processor configured to determine an identifier indicative of a user equipment (UE) functioning as a relay, wherein the identifier comprises a physical cell identifier (PCI) wherein the determining comprises selecting the PCI from a plurality of reserved PCIs for indicating the UE is functioning as a relay and transmit a broadcast signal including the identifier; and
memory coupled with the at least one processor.

83. An apparatus for wireless communications, comprising:
at least one processor configured to receive a broadcast signal including an identifier, wherein the identifier comprises a physical cell identifier (PCI) wherein the determining comprises selecting the PCI from a plurality of reserved PCIs for indicating the UE is functioning as a relay and determine, based on the identifier, that the broadcast signal was received from a user equipment (UE) functioning as a relay; and
memory coupled with the at least one processor.

84. An apparatus for wireless communications, comprising:
at least one processor configured to receive, at a user equipment (UE) functioning as a relay, first broadcast signals at a first interval from an apparatus serving the UE functioning as a relay and transmit second broadcast signals at a second interval, wherein the second broadcast signals are the same type as the first broadcast signals and wherein the second interval is greater than the first interval; and
memory coupled with the at least one processor.

85. An apparatus for wireless communications, comprising:
at least one processor configured to receive, from a user equipment (UE) functioning as a relay, first broadcast signals at a first interval and detect the UE functioning as a relay based on the first broadcast signals, wherein the first broadcast signals are the same type as second broadcast signals transmitted at a second interval by an apparatus serving the UE functioning as a relay and wherein the first interval is greater than the second interval; and
memory coupled with the at least one processor.

86. An apparatus for wireless communications, comprising:
at least one processor configured to means for determining, at a first user equipment (UE) functioning as a relay, a first frequency used for relaying data to or receiving data from a terminal UE and transmit a beacon at a second frequency different from the first frequency; and
memory coupled with the at least one processor.

87. A apparatus for wireless communications, comprising:
at least one processor configured to means for receiving, from a user equipment (UE) functioning as a relay, a beacon at a first frequency and discover the UE functioning as a relay based on the beacon, wherein the first frequency is different from a second frequency at which data is received from the UE; and
memory coupled with the at least one processor

88. A computer-program product for wireless communications, comprising:
a computer-readable medium comprising code for:
receiving, at a first user equipment (UE) functioning as a relay, data from a first apparatus; and
relaying the received data to a second apparatus without interpreting or altering security features of the received data.

89. A computer-program product for wireless communications, comprising:
a computer-readable medium comprising code for:
receiving a broadcast signal including an identifier, wherein the identifier comprises a physical cell identifier (PCI) wherein the determining comprises selecting the PCI from a plurality of reserved PCIs for indicating the UE is functioning as a relay; and
determining, based on the identifier, that the broadcast signal was received from a user equipment (UE) functioning as a relay.

90. A computer-program product for wireless communications, comprising:
a computer-readable medium comprising code for:
receiving, at a user equipment (UE) functioning as a relay, first broadcast signals at a first interval from an apparatus serving the UE functioning as a relay; and
transmitting second broadcast signals at a second interval, wherein the second broadcast signals are the same type as the first broadcast signals and wherein the second interval is greater than the first interval.

91. A computer-program product for wireless communications, comprising:
a computer-readable medium comprising code for:
receiving, from a user equipment (UE) functioning as a relay, first broadcast signals at a first interval; and
detecting the UE functioning as a relay based on the first broadcast signals, wherein the first broadcast signals are the same type as second broadcast signals transmitted at a second interval by an apparatus serving the UE functioning as a relay and wherein the first interval is greater than the second interval.

92. A computer-program product for wireless communications, comprising:
a computer-readable medium comprising code for:
determining, at a first user equipment (UE) functioning as a relay, a first frequency used for relaying data to or receiving data from a terminal UE; and
transmitting a beacon at a second frequency different from the first frequency.

93. A computer-program product for wireless communications, comprising:
a computer-readable medium comprising code for:
receiving, from a user equipment (UE) functioning as a relay, a beacon at a first frequency; and
discovering the UE functioning as a relay based on the beacon, wherein the first frequency is different from a second frequency at which data is received from the UE.
